(19) United States
(12) Patent Application Publication
(10) Pub. No.: US 2019/0318556 A1
(43) Pub. Date: Oct. 17, 2019

(54) 360-Degree Video and Data Recording and Security System

(71) Applicant: Michael J. Kintner, Olean, NY (US)

(72) Inventor: Michael J. Kintner, Olean, NY (US)

(21) Appl. No.: 16/367,721

(22) Filed: Mar. 28, 2019

Related U.S. Application Data
(60) Provisional application No. 62/761,389, filed on Mar. 22, 2018.

(51) Int. Cl. G07C 5/08; B60R 1/12; H04W 4/48

(52) U.S. Cl. CPC G07C 5/0866; B60R 1/12; B60R 2011/0085; B60R 2001/1253; H04W 4/48

(57) ABSTRACT

A recording and security system to record 360-degree video and other data. The system includes one ore move video cameras to record a 360-degree video of the viewable area around the one or more video cameras. The system further includes a control box and a local or remote data storage system. The one or more video cameras may be communicatively coupled to the control box where the control box may locally store the recordings or transmit the recordings to the remote data storage system.

### BACKGROUND OF THE INVENTION

The present subject matter relates generally to a video and data recording system. More specifically, the present invention provides a 360-degree video and data recording and security system.

Generally, in-vehicle video recording systems are used to record video inside and/or outside a vehicle to track crashes, break-ins, or other events that may take place near or around the vehicle. These systems include one or more video cameras that can be mounted to the vehicle's dashboard, front windshield, rearview mirror, back windshield, and/or bumper. The system is generally powered through the vehicle's power source (i.e., car battery). In most instances, the video camera begins to record video when the vehicle is started by the driver. The recorded video is saved onto a removable storage device located within the video recording system. When the removable storage device reaches its storage limit, the video recording system will begin to overwrite the oldest files in a never-ending loop, thus limiting the viewing length of the recorded video. Additionally, recordings stored locally in the vehicle are not accessible from a remote location, such as a web browser or mobile application.

If a user wishes to record video in more than one direction around the interior and exterior of the vehicle, they must install multiple video cameras. For example, if the user wishes to record video in front of and to the sides of the vehicle, they must install one camera facing out from the front of the vehicle and another camera facing out from the sides of the vehicle. In this scenario, the video system stores each video recording as a separate video file. When a user wishes to view the video, they must remove the storage device(s) and input it into a video output display such as a computer, mobile device, or television. Because each recording is a separate video file, the user may not get a full view and understanding of what happened at a specific point in time without syncing each video to the same point in time, which can be a cumbersome task.

Depending on the storage size of the removable devices, the user may not be able to view recorded video from beyond a certain time period. For example, a 64-gigabyte removable storage device can store approximately 128 minutes of 4K high definition spherical video. This means that the user can only view video of the last 128 minutes of the vehicle video recording. Unless the video system is put into endless loop recording only saving the last 128 minutes of viewing. This limitation can severely hamper the benefits of the user's vehicle recording system, specifically in instances where the vehicle has been burglarized, vandalized, stolen, or in an accident. Furthermore, in-vehicle storage devices can be easily stolen.

Moreover, most in-vehicle recording systems include an on-board display such that a user can view the video while it is being recorded. The on-board display not only distracts the driver, but makes the vehicle an easy target for break-ins.

Accordingly, there is a need for an in-vehicle recording system that records the 360-degree area inside and outside a vehicle and also records other vehicle tracking data and stores all the recordings to an offline data storage system for remote access, as described herein. Additionally, there is a need for an in-vehicle recording system where the video recordings are stored as a single video file, as described herein.

### BRIEF SUMMARY OF THE INVENTION

To meet the needs described above and others, the present disclosure provides an in-vehicle 360-degree video and data recording system that records the area inside and/or outside a vehicle along with other vehicle data (i.e., speed, geolocation, acceleration, etc.) and stores the video recording to a remote data storage system in single video file and data file that can be viewed and accessed remotely.

In one embodiment, the present disclosure provides an in-vehicle 360-degree video and data recording system (“vehicle recording system”) that includes one or more video cameras that provide a 360-degree view of the vehicle's surroundings. Each video camera may include a front facing lens and a rear facing lens. Together, the two lenses provide a 360-degree video of the surrounding area.

The one or more video cameras may be coupled to a control box and may be mounted to the rearview mirror and/or the back windshield of a vehicle. The video cameras may also include a microphone to record audio. The control box may be stored under the dashboard of the vehicle and used to process and upload the video recordings and other vehicle data to a remote data storage system.

The vehicle recording system may be powered through the vehicle's power supply (e.g., car battery) or a stand-alone power source including a battery and/or renewable energy, such as solar power, wind power, or hydro power. In one example, the control box may include a power module that is coupled to the vehicle's power supply so as to receive electric power.

Additionally, the control box may include an on-board diagnostics (OBD) module that is coupled to the vehicle's OBD system. Through the OBD module, the control box can record vehicle data including the vehicle's speed, revolutions per minute (RPM), pedal position, tire pressure, coolant temperature, airflow rate, battery status, geolocation (i.e., GPS location) or other vehicle parameters at any given time.

The control box may also include a radio frequency (RF) module that allows it to wirelessly upload the recorded video and vehicle data to the remote data storage system. The RF module may include one or more wireless chipsets, including cellular, Wi-Fi, satellite, RFID, and Bluetooth. The cellular chipset may be able to transmit and receive data via a various cellular technologies, including 2G, 3G, 4G, and 5G cellular technologies such as United Mobile Telecommunications Service (UMTS), Code Division Multiple Access (CDMA), and Long Term Evolution (LTE).

Furthermore, the control box may include software that allows it to process and upload the recorded video and vehicle data to a remote data storage system, such as a cloud storage system (e.g., Apple iCloud, Amazon Web Services, Google Cloud), home computer, or smartphone. The vehicle recording system may also include a 3-axis gyroscope, 3-axis accelerometer, and other sensors to record additional vehicle data outside of the vehicle's OBD system.

In operation, the vehicle recording system may begin to record video, OBD data, and/or other vehicle data when a user starts the vehicle. Alternatively, the vehicle recording system may record video and/or data when the vehicle is not running. For example, the vehicle recording system may record video and/or data 24×7 or at a preset time. The vehicle recording system may also include a sensor, that when triggered, begins to record video and/or data. In another example, the vehicle recording system may be activated from a remote location via a computer, mobile device, or remote key.

The recorded video may consist of a fully spherical 360-degree video recording from the front facing lens and the rear facing lens. The recorded 360-degree video and vehicle data are sent to the control box where the control box may process the video recordings and vehicle data. After processing, the control box, via a wireless network, such as a cellular or other wireless network, uploads the video recordings and vehicle data to the remote data storage system.

In one embodiment, the vehicle recording system may include a front facing and rear-facing dual lens video camera. Such video cameras include opposing front and rear-facing fish-eye or wide-angle lenses that allow 360-degree field of view from a single camera unit. The recorded video from the dual lens camera is uploaded and stored as a single file in a equirectangular 360-degree video format. Therefore, a full 360-degree field of view may be accomplished by the disclosed 360-degree vehicle recording system.

In another embodiment, the vehicle recording system may include both a front dual lens (i.e., 360-degree) camera and a rear dual lens camera. In this instance, the vehicle recording system will record two separate 360-degree video streams in an equirectangular 360-degree video format.

The control box may include local storage, such as a removable microSD card, conventional hard drive or solid-state drive. The local storage may be used to store the queued video recording and OBD data during times when the vehicle is out of network range and thus unable to upload the information to the remote data storage system. When the vehicle is in network range, the control box may upload the video recordings and vehicle data to the remote data storage system.

The vehicle recording system may include a web server and/or online control center that allows a user to view the video recording and vehicle data in real time. The control box may also include Bluetooth or RFID capabilities such that a mobile device can connect to the control box via a Bluetooth or RFID connection and view the vehicle recordings and data in real time and make changes to the system, such as video quality, frame rate or other video parameters.

In another embodiment, the vehicle recording system may record video and vehicle data even during times when the vehicle is not powered on. For example, the vehicle recording system may be powered by the vehicle's on-board power supply (i.e., car battery) or a stand-alone power source. When using the vehicles' on-board power supply, the vehicle recording system will not drain the power source while recording when the vehicle is off.

In another embodiment, the vehicle recording system may include a notification system that alerts a user when an event occurs, such as the vehicle going over a designated speed threshold, the vehicle moving during a time it is should be idle, or the vehicle being broken into. Further, the notification system may alert the user if the vehicle power is getting low. The notification system may send alerts via a multitude of methods, including SMS or email.

Although the previous embodiments describe the vehicle recording system for use in a vehicle, the recording system is not limited to vehicular use. A person of ordinary skill in the art will understand that the disclosed recording system may be used as a remote video recording system in almost any location where such surveillance is needed, but the locations network connectivity is through a cellular network, such as classrooms, business offices, and homes. In instances where power is an issue, the video recording system may be powered with other power sources, including batteries and/or renewable energy, such as solar power, wind power, or hydro power.

The vehicle recording system records a 360-degree area in one file and uploads the recording to a remote data storage system where a user can remotely access the recording.

The vehicle recoding system, if connected to a local or cellular network, allows a user to see live video and audio streamed directly from the vehicle or remote location.

The vehicle recording system records a 360-degree video of interior and exterior of a vehicle.

The vehicle recording system includes dual lens 360-degree video cameras.

The vehicle recording system records information and data from a vehicle's OBD system.

The vehicle recording system can inject the OBD data as metadata into the video recording.

The vehicle recording system can upload video and OBD data recordings to a remote data storage system.

The remote data storage system can allow a user to view many months of recorded video and vehicle data.

The vehicle recording system can live stream 360-degree video and/or audio to the Internet for remote viewing.

The vehicle recording system can live stream OBD data to the Internet for remote viewing.

The vehicle recording system can upload video and vehicle data recordings to a remote data storage system via a wireless network, such as a cellular network.

The vehicle recording system can store more video and data recordings than an in-vehicle data storage system.

The remote data storage system can be remotely accessed by a user through, for example, a web browser or mobile application.

The vehicle recording system can be powered through a vehicle's on-board power system (e.g., car battery).

The vehicle recording system can be powered through stand-alone power sources including batteries and/or renewable energy, such as solar power, wind power, or hydro power.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

FIG. 1 is a perspective view of the vehicle recording system.

FIG. 2 is a perspective view of the video camera.

FIG. 3 is a front perspective view of an embodiment of the video camera attached to a rearview mirror for use in the 360-degree video vehicle recording system.

FIG. 4 is a back-perspective view of the rearview mirror of FIG. 3.

FIG. 5 is a front perspective view of another embodiment of the video camera attached to a rearview mirror for use in the 360-degree video vehicle recording system.

FIG. 6 is a front perspective view of another embodiment of the video camera attached to a rearview mirror for use in the 360-degree video vehicle recording system.

FIG. 7 is a back-perspective view of the rearview mirror of FIG. 6.

FIG. 8 is a front view of the rearview mirror of FIG. 6.

### DETAILED DESCRIPTION OF THE INVENTION

The present disclosure provides an in-vehicle video and data recording system that records the area inside and/or outside a vehicle and stores the video and data to a remote data storage system for remote access and viewing. The video recording is stored in single video file that can be viewed and accessed over the Internet.

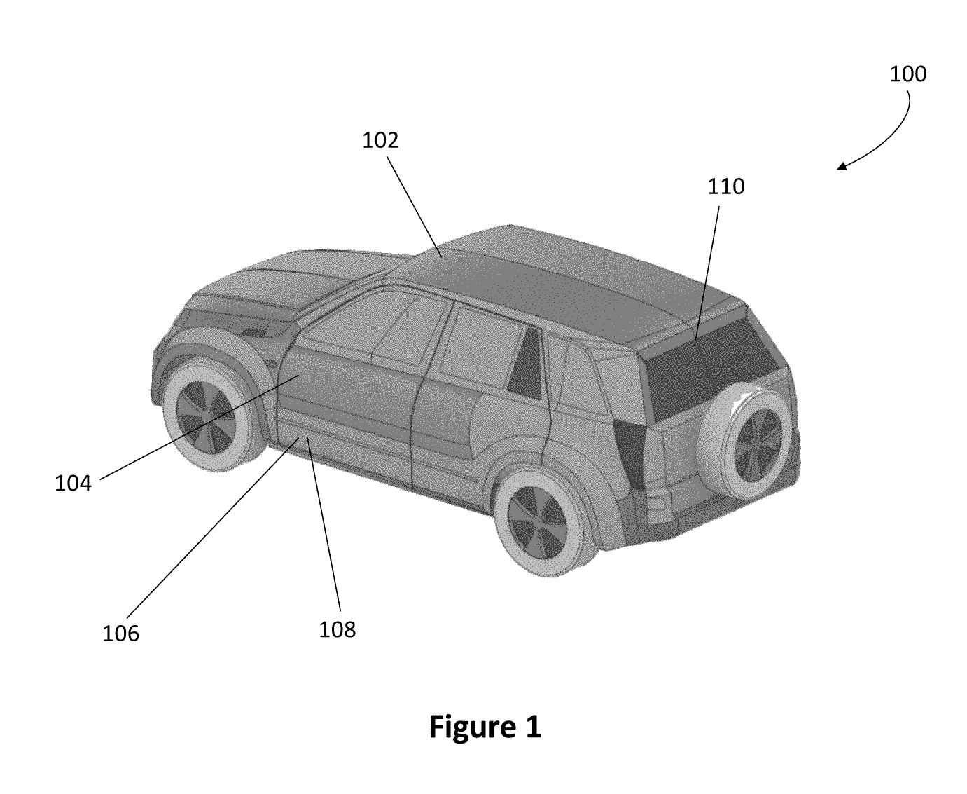

FIG. 1 illustrates one embodiment of a vehicle recording system 100 capable of recording 360-degree video recording system. As shown in FIG. 1, the vehicle recording system 100 may include a video camera 102, an underdash control box 108, an OBD connector 104 coupled to an OBD system 106, and an optional rear camera 110. The video camera 102, OBD system 106, and optional rear camera 110 are communicatively coupled to the underdash control box 108. When the vehicle is stationary or in operation, the vehicle recording system 100 records video and OBD data. Via a wireless network, such as a Wi-Fi or cellular network, the recordings may be directly uploaded to a remote data storage system. The video and data recording, if connected to the network, can stream data to a remote user to view in real time. The vehicle recording system 100 may also include an on-board storage device, such as a flash drive or hard drive, that can be used to locally store the recordings in the event that the vehicle is out of range of a wireless network.

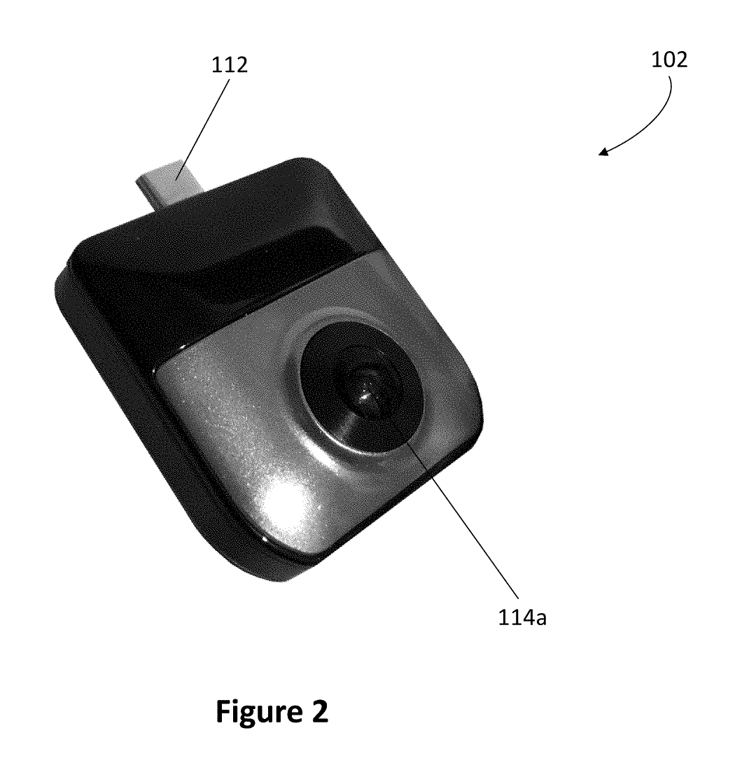

FIG. 2 illustrates one embodiment of the video camera 102 used in the vehicle recording system 100. As shown in FIG. 2, the video camera 102 may include a front facing camera lens 114a and an output port 112 enabling it to be coupled to the underdash control box 108. The video camera 102 may include a rear facing camera lens 114b such that it can record fully spherical 360-degree videos. The front facing lens 114a and rear facing lens 114b may be one of a variety of lenses, including, but not limited to fish-eye or wide-angle lenses.

The 360-degree video recordings are stored in an equirectangular 360-degree video format. The recorded video from the front facing lens 114a and rear facing lens 114b may be integrated at the control box 108 or at the remote data storage system such that the two video recordings are stored as a single video file. Therefore, a full 360-degree field of view may be accomplished by the disclosed vehicle recording system 100.

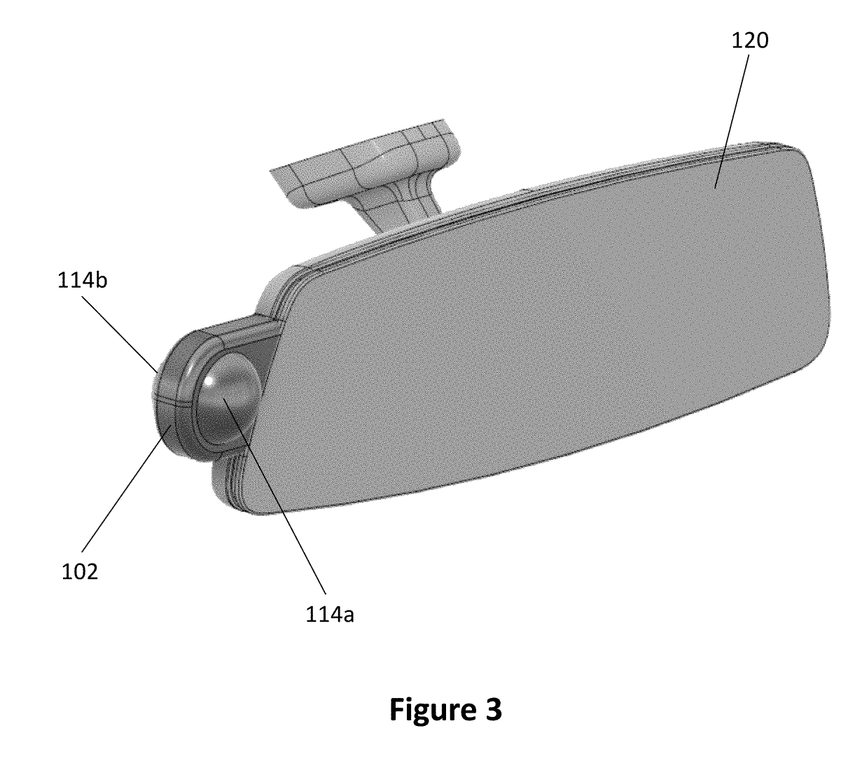

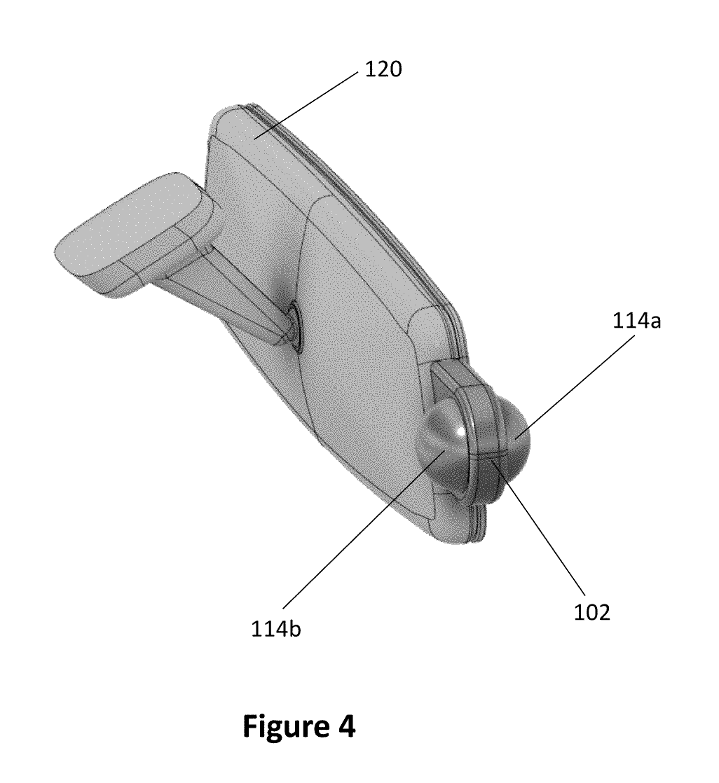

FIGS. 3 and 4 illustrate one embodiment of the video camera 102 attached to a rearview mirror 120. As shown in FIGS. 3 and 4, the video camera 102 may be attached to the left side of the rearview mirror 120. The video camera 102 may include front facing lens 114a and rear facing lens 114b, allowing a 360-degree field of view from a single camera unit.

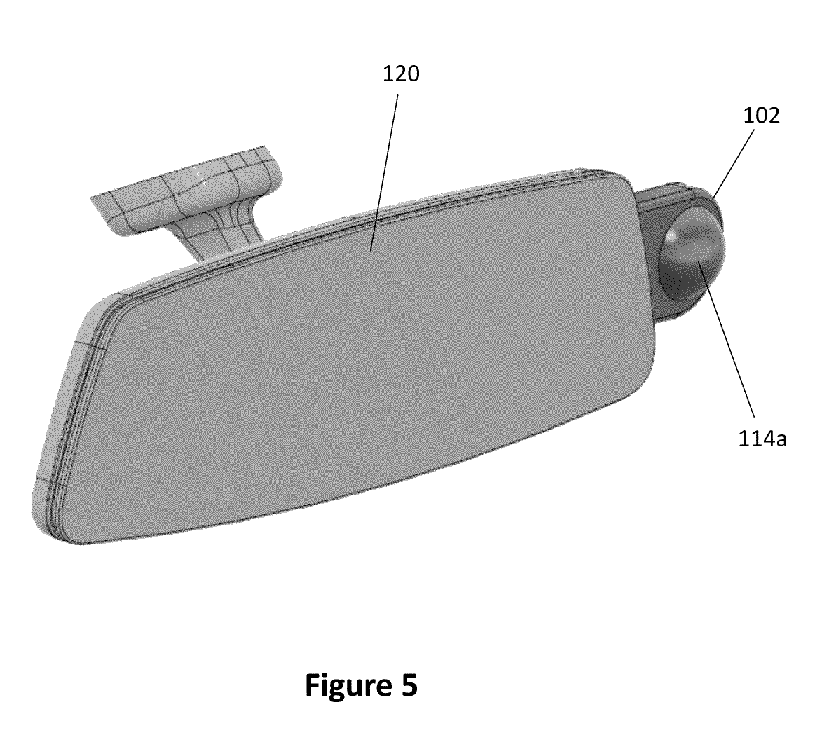

FIG. 5 illustrates another embodiment of the video camera 102 attached to a rearview mirror 120. In this configuration, the video camera 102 is attached to the right side of the rearview mirror 120. The video camera 102 may include front facing lens 114a and rear facing lens 114b, allowing a 360-degree field of view from a single camera unit.

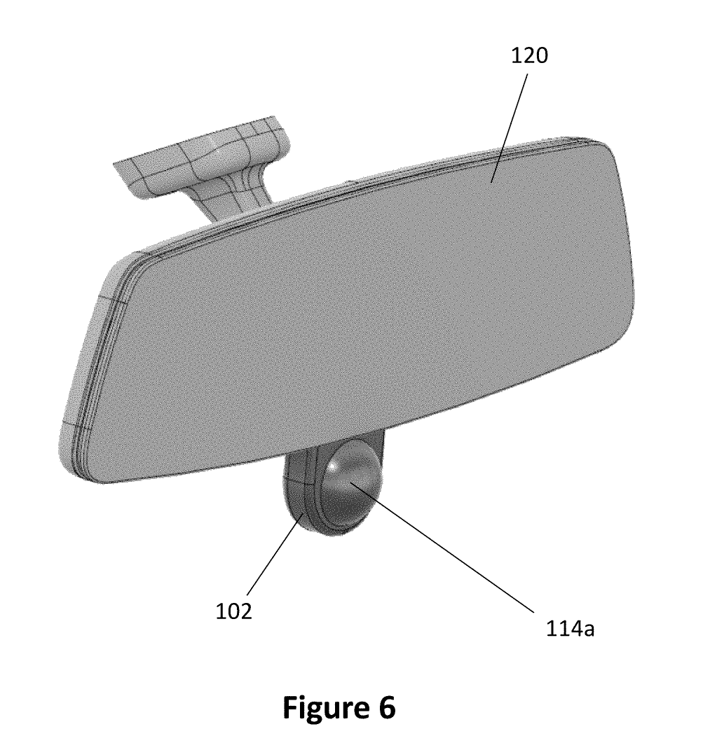

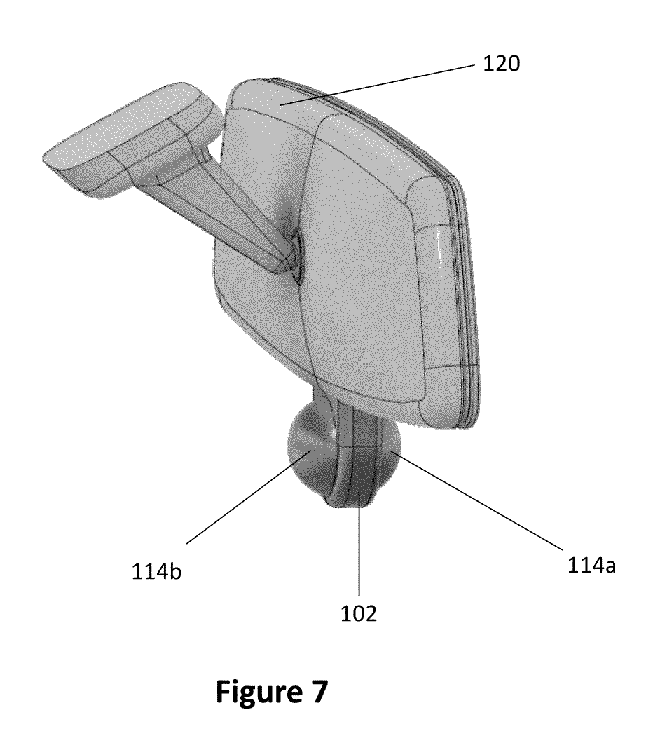

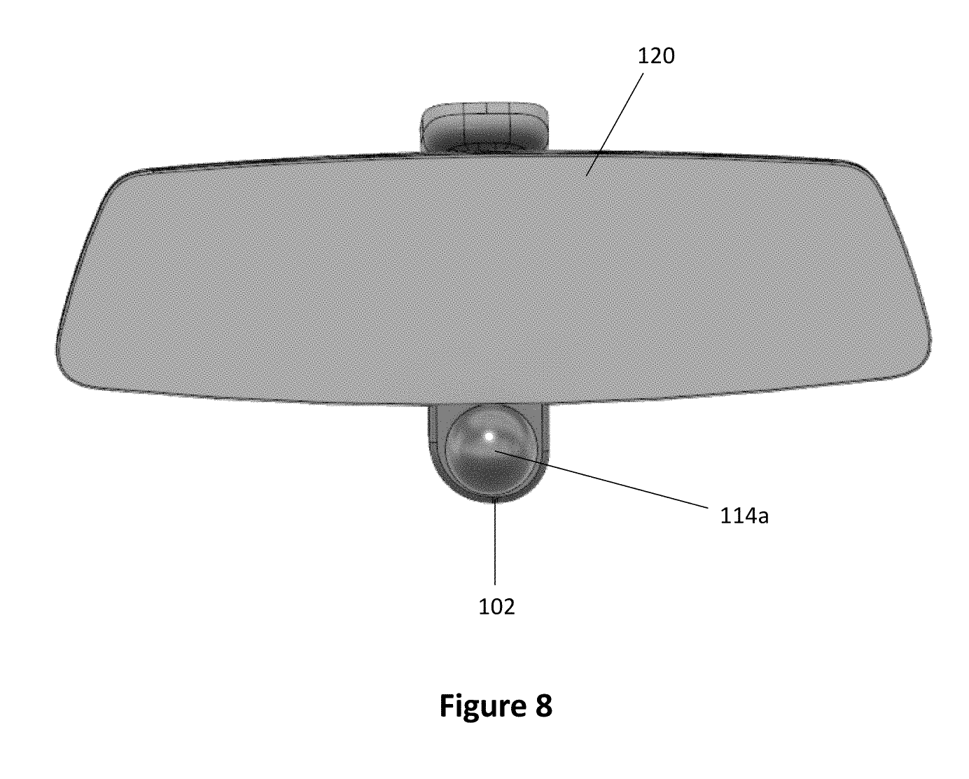

FIGS. 6 to 8 illustrates yet another embodiment of the video camera 102 attached to a rearview mirror 120. As seen in FIGS. 6 to 8, the video camera 102 may be attached to the bottom of the rearview mirror 120. The video camera 102 may include front facing lens 114a and rear facing lens 114b, allowing a 360-degree field of view from a single camera unit.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A 360-degree video recording system, comprising:
one or more video cameras wherein each camera provides a 360-degree view of surroundings;
a control box; and
a local or remote data storage system;
wherein the video cameras are communicatively coupled to the control box;
wherein the video cameras record video can be both stored locally or transmits the 360-degree view to the control box; and
wherein the control box transmits the 360-degree view to local storage system or the remote data storage system.

2. The system of claim 1 wherein the control box transmits 360-degree video recording to the remote data storage system by use of a wireless network.

3. The system of claim 2 wherein the wireless network is a cellular network.

4. The system of claim 1 wherein the control box is communicatively coupled to a vehicle's on-board diagnostic system and records vehicle data.

5. The system of claim 4 wherein the vehicle data includes the GPS location of the vehicle.

6. The system of claim 4 wherein the vehicle data includes the speed of the vehicle.

7. A method for recording 360-degree video, comprising:
one or more video cameras wherein each camera is configured to provide a 360-degree field of vision and communicatively coupled to a control box; and
wherein the video cameras record a 360-degree video and transmit the recorded 360-degree video to the control box;
wherein the control box transmits the 360-degree video to a remote data storage system.

8. The method of claim 7 wherein the control box transmits the recorded 360-degree video to the remote data storage system by use of a wireless network.

9. The method of claim 8 wherein the wireless network is a cellular network.

10. The method of claim 7 wherein the control box is communicatively coupled to a vehicle's on-board diagnostic system and records vehicle data.

11. The method of claim 10 wherein the vehicle data includes the GPS location of the vehicle.

12. The method of claim 10 wherein the vehicle data includes the speed of the vehicle.

13. The method of claim 10 wherein the other vehicle data collected from the OBD system can be stored in the control box.

14. The method of claim 13 wherein the data can be transmitted to the remote data storage system.

15. The method of claim 14 wherein the wireless network is a cellular network.
